(19) United States
(12) Patent Application Publication
(10) Pub. No.: US 2023/0327443 A1
(43) Pub. Date: Oct. 12, 2023

(54) CHARGING APPARATUS

(71) Applicant: SANDVIK MINING AND CONSTRUCTION OY, Tampere (FI)

(72) Inventors: Harri ERIKSSON, Tampere (FI); Jaakko VIERIKKO, Tampere (FI)

(21) Appl. No.: 18/024,811

(22) PCT Filed: Sep. 7, 2020
(86) PCT No.: PCT/EP2020/074922

§ 371 Date: Mar. 6, 2023

(51) Int. Cl. H02J 3/12; H02J 7/00; E21F 17/06

(52) U.S. Cl. CPC H02J 3/12; H02J 7/0047; H02J 7/00712; H02J 7/0013; E21F 17/06; H02J 2310/52; B60L 2200/40; B60L 53/63

(57) ABSTRACT

A charging apparatus includes one or more charging ports and monitors incoming voltage. If the charging apparatus detects a decrease in the incoming voltage it limits charging power in a charging port. If there are several active charging ports a priority configuration can be used for prioritizing different charging ports.

This disclosure relates to charging electric equipment. Particularly this disclosure relates to charging equipment, such as vehicles, requiring high charging power in a limited electric grid.

Electric equipment is widely used in various applications. Electric equipment comes in all sizes and they have different requirements with regard charging power. A common example requiring high charging power is a car because car requires a lot of power. Thus, cars commonly have large batteries and in order to keep the car usable the battery needs to be charged rapidly. Fast charging stations are commonly coupled to energy network by using a high-power connection that can provide enough electricity for each of the charging stations.

A similar need for high power may occur in working machines. Working machines can be equipped with large batteries so that they can be used for longer periods without unproductive pauses during the working period. Some of the working machines are heavy duty machines that also consume a lot of power. Thus, they may need to be recharged during the working period and in such case the charging speed should be as fast as possible so that critical machines are not out of work longer than needed.

One special example of a field involving such machines is mining industry. Mining is power consuming, however, electricity grids in mines are often of limited quality. Mining environment causes both technical and economical limitations that need to be considered when an electricity grid is constructed to a mine. Furthermore, the load in an electricity grid in a mine is typically variable because different tools and machines are recharged and used in irregular intervals.

A further characteristic with mines is that they may be in a remote location. The distribution network line or public network may be insufficient for providing the needed electricity. In such cases additional electricity is provided using local power sources, such as diesel generators. Using generators is expensive and particularly situations where additional power is needed also additional costs are caused because of starting additional generator capacity. Thus, it is desired to keep the required peak power as low as possible while still providing enough electricity for the operation of the mine.

Thus, the need for power varies. If the charging, or otherwise used, power increases too much the load can cause a drop in the power supply. This affects to all machines connected to the electricity grid and may even cause a total power outage.

### SUMMARY

In the following a charging apparatus having one or more charging ports is disclosed. The charging apparatus monitors incoming voltage and if it detects a decrease in the incoming voltage it limits charging power in a charging port. If there are several active charging ports a priority configuration can be used for prioritizing different charging ports.

In an aspect a charging apparatus is disclosed. The charging apparatus comprises an electric input, at least one charging port configured to charge a battery connected to the charging port, and a circuitry comprising a voltage measurement device. The circuitry is configured to provide electric power from the electric input to the at least one charging port. The circuitry is further configured to: monitor the incoming voltage using the voltage measurement device, detect a decrease in the monitored incoming voltage, and limit the electric power at a charging port as a response to the detected decrease.

It is beneficial to monitor condition of the electricity grid. A decrease in voltage may be an indication that the grid or a feeding line is overloaded and reducing charging power releases the power for other purposes. This is particularly beneficial when electric power transfer capacity of the feeding line is at the limit. This may happen when the devices and machines connected to the feeding line are requiring more power than the feeding line is capable of supplying. Additionally, this may help keeping the grid operational and costly shutdowns of the grid or firing additional electricity production capacity can be reduced or even completely avoided. Monitoring the voltage is beneficial as it provides means for detecting possible overloading without any further communication capability. Thus, it is very suitable for mining environment, wherein the communication possibilities are limited.

In an example implementation the charging apparatus comprises two or more charging ports. It is beneficial to be able to charge more than one machine simultaneously.

In an example implementation the circuitry is configured to provide to each charging port an equal charging power. In another the charging apparatus is configured to detect a priority configuration and to limit the electric power in a charging port according to the priority configuration. In a further example the priority configuration is configured to prioritize the first connected battery. In a further example the priority configuration is configured to prioritize a battery having a priority indication. It is beneficial to have different priority configurations so that important machines can be charged as fast as possible and less important can be charged using less power if available. It is beneficial that the indication may be permanent or can be changed so that when it is known that a machine is not needed for longer period it can be charged slowly or even disconnected when there is not enough charging power to charge prioritized machines.

In an aspect a mining machine charging arrangement is disclosed. The arrangement comprises an electrical substation located in a mine. The electrical substation is connected to a distribution network line. The arrangement further comprises a feeding line in a mine tunnel. The feeding line is connected to the electrical substation. The arrangement further comprises a charging apparatus as described above. The charging apparatus is connected to the feeding line.

In an aspect a method for charging a battery in a mine is disclosed. The method comprises initiating a charging session, monitoring the incoming voltage at a charging arrangement, detecting a decrease in the monitored incoming voltage and limiting the charging power of the charging session.

In an example implementation the method further comprises starting at least one additional charging session. In another example the method further comprises limiting charging power in each of the charging sessions equally. In a further example the method further comprises detecting priority configuration and limiting the charging power according to the priority configuration. In a further example the method further comprises prioritizing the first started charging session. In a further example the method further comprises prioritizing the charging session comprising a priority indication.

In an aspect a computer program is disclosed. The computer program comprises instructions, which when executed by a computing device, cause the computing device to carry out a method as disclosed above.

### BRIEF DESCRIPTION OF THE DRAWINGS

The accompanying drawings, which are included to provide a further understanding of the charging apparatus and constitute a part of this specification, illustrate examples and together with the description help to explain the principles of the charging apparatus. In the drawings:

FIG. 1 is a block diagram of an example of an environment with a charging apparatus;

FIG. 2 is an example of a method for charging a battery of a vehicle; and

FIG. 3 is an example of a method for charging a battery of two or more vehicles.

### DETAILED DESCRIPTION

Reference will now be made in detail to the examples which are illustrated in the accompanying drawings.

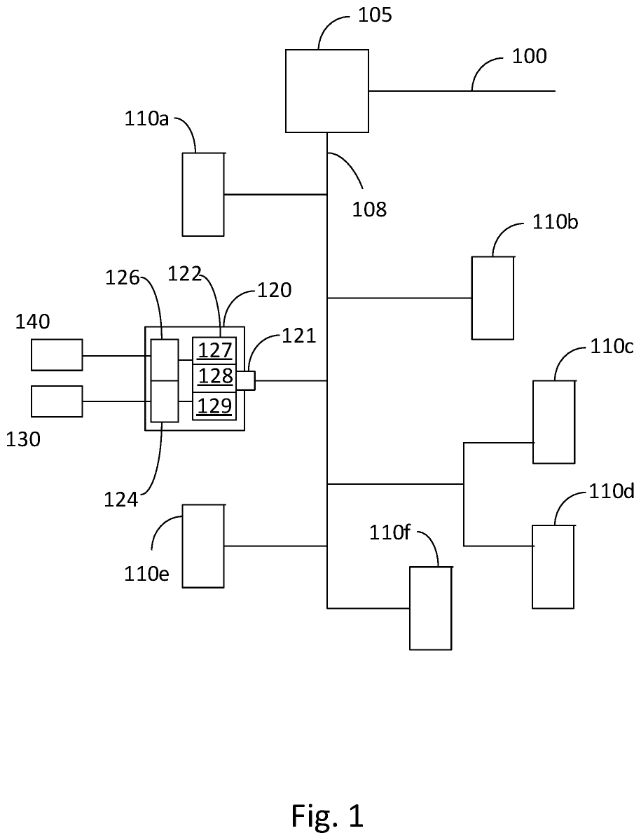

In FIG. 1 a block diagram of an example of an environment with a charging apparatus is shown. The environment may be, for example, a mine or a part of a mine. In the apparatus electricity is fed into the system using a distribution network line 100 and a electrical substation 105. The capacity of the distribution network line 100 and the electrical substation 105 varies according to the availability of electricity. For example, if the mine is in a remote location, the distribution network line 100 feeding the electrical substation 105 may be of limited capacity. The substation transforms the voltage of the distribution network line to the one used in the mine.

In the example of FIG. 1 the electrical substation is providing electric power using a feeding line 108, which is a feeding line from the electrical substation 105, that is providing electricity to one branch of the mine. The quality of feeding lines varies. They may be old or more recently installed. One common problem is that feeding lines are often very long and thin. If the voltage drops the required current to maintain the power level may be too high for the feeding line 108. In the example of FIG. 1 only one feeding line is shown, however, it is possible that there are several feeding lines. The feeding line 108 is connected to provide electric power to machines 110a-110f. These machines may include tools that require direct electricity, or they may use batteries and a charging station. These machines may be related directly to mining, such as drilling and crushing, or they may be supporting tools, such as lights, water pumps and similar. These machines are distributed all over the mine and the overall load generated by these machines is variable. In case of several feeding lines the feeding lines may be arranged so that there is one for each segment in the mine, wherein the segments may be in different tunnels and branches of the mining system. The need for limiting electricity may be caused because a feeding line does not have enough capacity. In this case it is sufficient that a limitation is applied only the respective branch of the mining system. In another scenario the need for limiting electricity may be caused because of the electrical substation is not capable of providing more electricity from the distribution network. In this case the need for limiting electricity can be relevant for the whole mine.

In the example of FIG. 1 a charging apparatus 120 is connected to the feeding line 108 using an electric input 121. The charging apparatus 120 is used to charge two heavy electric vehicles 130 and 140. In the example of FIG. 1 heavy vehicles are used as examples because they often require high charging powers, however, also other machines with high capacity batteries could be used. In the example of FIG. 1 and in the following examples charging a vehicle is discussed. In such case the vehicle comprises one or more batteries which are charged directly from the charging apparatus or using additional electric components that receive charging power from a charging apparatus and charge batteries installed in the vehicle.

The electric grid in a mine is commonly not designed for high charging powers. One problem in designing mining grids is that the grids can be temporary and depending the expected life of a mine. Thus, the grids are designed carefully to fulfil the minimum requirements at the lowest possible cost because over investment will cause unnecessary loss of money. Because of this the grids are often used at their limits and the obvious solution of providing a more capable electric grid is not a possible or economical solution. The tunnels do have limited space and improving the grid might require drilling additional passages for feeding lines.

In the example of FIG. 1 the charging apparatus comprises a circuitry 122 that is configured to distribute electric power from the feeding line 108 to between a first charging port 124 and a second charging port 126, to which heavy vehicles 130, 140 are connected to. The circuitry 122 comprises at least means for measuring incoming voltage 127, such as a voltage meter, internal voltage information of a variable frequency drive or similar. Additionally, the circuitry may comprise means for processing information 128, such as a processor and a means for storing data 129, such as a memory, hard disk or similar. Instead of a processor and memory, or similar, the circuitry may comprise other components that are suitable for limiting and distributing electric power may be used.

The circuitry 122 is configured to distribute the electric power between charging ports 124, 126 by using a distribution scheme. Examples of different distribution schemes are described in below. The voltage measurement device of the circuitry is configured to monitor the incoming voltage continuously. The monitored voltage is used when deciding how the electricity is distributed in cases, where there is a need for limiting the used charging power.

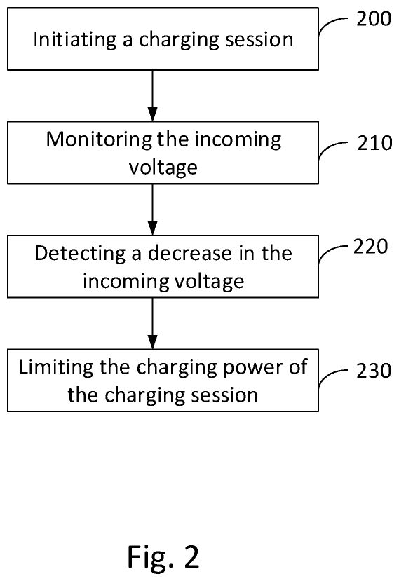

FIG. 2 discloses a method used in an example of the charging apparatus. In the example of FIG. 2 only one vehicle is charged. This can be done using a single charging port charging apparatus, or with a charging apparatus similar to the example of FIG. 1. If the charging apparatus of FIG. 1 is used, the example of FIG. 2 assumes that only one of the charging ports is used.

The method is started by initiating a charging session, step 200. The charging session is initiated by plugging in a device into a charging port. The charging speed at the initiation is variable depending on the charged vehicle and the state of charge. Different vehicles have different capabilities of receiving power and the capability also varies depending on the power left in the battery of the vehicle when the charging is initiated. Thus, also the power received from the electric grid is variable. The vehicle may be connected to the charging port using a simple cable that is only capable of transmitting electric power but does not provide any means for communication. However, it is common that the charging cable may be able to transmit information from the vehicle, such as a vehicle identification or other charging session relating information. Furthermore, in more advanced examples the vehicle may be connected automatically either using a mechanical arrangements or wireless charging methods.

During ordinary charging the charging apparatus monitors the incoming voltage, step 210. A change in the incoming voltage may be an indication of a change in the overall load in the electric grid. If the overall load is low a charging session can be completed by providing maximum power to the charged vehicle. However, it is possible the monitoring detects a situation, wherein the incoming voltage is decreased, step 220. Thus, there may be a shortage of electric power in the grid. As a response to the detected decrease, the charging apparatus limits the charging power of the charging port currently used, step 230. When the charging power is reduced, the impact to the electric grid is also reduced. Reducing the charging power can be done using several methods. For example, the charging current can be reduced in relation to the voltage. This may be implemented, for example, doing a straight-forwarded calculation or a look-up table, wherein charging current is determined for the charging apparatus as whole. The charging apparatus then distributes the charging power according to the possible priority settings.

In the above the example method of FIG. 2 is explained in a manner that only one of the charging ports is used. The method of FIG. 2 can be used also when two or more charging ports are used and none of the charging ports has a priority over other charging ports. For example, in case of two charging ports the charging power may be distributed equally. Thus, when the charging power is reduced it is reduced evenly from both of the charging ports.

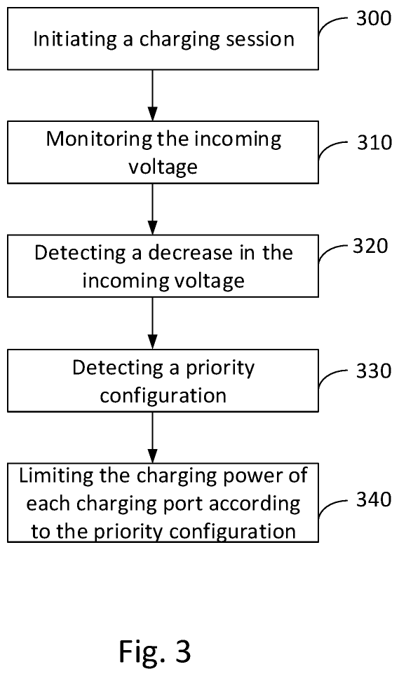

FIG. 3 discloses an example of a method used in a charging apparatus. First, a charging session is initiated, step 300. This differs from the example of FIG. 2 in that there is at least one charging session active before the initiation of the new charging session. The incoming voltage is monitored accordingly as in the example of FIG. 2. The incoming voltage should be maintained even if the number of vehicles to be charged is higher than one. Thus, if a decrease in the incoming voltage is detected at step 320, then the charging power needs to be limited. This provides maintaining good quality of the grid so that devices connected to the grid are not interfered and unnecessary restarts and boot sequences are avoided in machines that are connected to the grid.

In the example of FIG. 3 the limitation is not done evenly but first existence of a priority configuration is detected, 330. The priority configuration is a rule or set of rules which will be followed when limiting the charging power. In the example of FIG. 3 the limitation is then done for each charging port according to the priority configuration, step 340.

An example of a priority configuration is a “first in, first out” principle. When it is applied the power is limited for the lastly connected vehicle or battery pack. Thus, when the first connected vehicle receives more charging power it will be fully charged before the later connected vehicle. In a more advanced implementation, the “full charge” can be determined as a certain state of charge, such as 80%. This is beneficial because many batteries do not charge fast after certain state of charge. Furthermore, in some applications the 100% charge is not preferred as it may lead into battery deterioration. Thus, when the determined state of charge equaling “full charge” has been reached more charging power will be provided to later connected vehicle or battery.

Another example of a priority configuration is using the state of charge. In such configuration the charging power with higher state of charge is limited. This may be beneficial for optimizing overall charging times as batteries with lower state of charge generally can be charged with higher charging rates.

The examples given above do not require any communication capabilities or additional information of the vehicle. However, more advanced implementations may use additional information, such as an identification received from the charged vehicle, desired charging time and similar. For example, when a vehicle is connected to the charging apparatus, a handshake procedure between the charging port and the vehicle will be performed. Consequently, the charging port recognizes the vehicle. The information received during handshake procedure may contain, for example, an indication of a high priority vehicle. In such case the higher priority vehicle will be charged first. Accordingly, a low priority vehicle may be indicated. If handshake procedure is not available, the similar functionality may be implemented, for example, using priority buttons at the charger. Instead of physical buttons other user interface means, such as touch displays or remote controls, may be used for indicating the charging priority.

If a charging time is indicated the charging apparatus may limit the charging power so that the full charge is achieved by the indicated time but not earlier. The desired charging time may be entered, for example, by using a control panel at the charging apparatus. Using the desired charging time, the charging apparatus may charge the indicated vehicle using charging power sufficient to achieve the full status or any other indicated state of charge by the indicated time and use all additional power to charge other connected vehicles or batteries. This will reduce the requested peak power and also voltage drops as the power usage is distributed over a longer period. Additionally, this type of low power maintenance charging can be assigned very low priority meaning that it can be switched off completely when voltage drops. Furthermore, it is possible to determine different threshold voltages for different priorities. Thus, a low priority maintenance charging can be switched of earlier so that the need for limiting charging power for higher priorities is reduced or even avoided.

The priority configuration may be used to limit lower priority charging ports or even close them completely. In such case the highest priority charging port can use all available charging power in order to speed up the charging process. However, the limitation may be performed using different ratios for distributing the available charging power. For example, in a charging apparatus with two charging ports the priority division could be 75% for the higher priority and 25% for the lower. The ratio may be predetermined and fixed or it can be changed using a control panel at the charging apparatus. Furthermore, if the vehicle connected to the prioritized charging port cannot use the available 75% of the charging power the additional power can be distributed to other charging ports.

The above-mentioned method may be implemented as computer software which is executed in a computing device, which may be integrated at the charging apparatus. When the software is executed in a computing device it is configured to perform the above described inventive method. The software is embodied on a computer readable medium so that it can be provided to the computing device, such as the circuitry 122 of FIG. 1.

As stated above, the components of the examples can include computer readable medium or memories for holding instructions programmed according to the teachings of the present inventions and for holding data structures, tables, records, and/or other data described herein. Computer readable medium can include any suitable medium that participates in providing instructions to a processor for execution. Common forms of computer-readable media can include, for example, a floppy disk, a flexible disk, hard disk, magnetic tape, any other suitable magnetic medium, a CD-ROM, CD±R, CD±RW, DVD, DVD-RAM, DVD±RW, DVD±R, HD DVD, HD DVD-R, HD DVD-RW, HD DVD-RAM, Blu-ray Disc, any other suitable optical medium, a RAM, a PROM, an EPROM, a FLASH-EPROM, any other suitable memory chip or cartridge, a carrier wave or any other suitable medium from which a computer can read.

It is obvious to a person skilled in the art that with the advancement of technology, the basic idea of the charging apparatus may be implemented in various ways. The apparatus and its embodiments are thus not limited to the examples described above; instead they may vary within the scope of the claims.

1. A charging apparatus comprising:
an electric input;
at least one charging port configured to charge a battery connected to the charging port; and
a circuitry including a voltage measurement device, wherein the circuitry is configured to provide electric power from the electric input to the at least one charging port; and wherein the circuitry is further configured to monitor the incoming voltage using the voltage measurement device, detect a decrease in the monitored incoming voltage, and limit the electric power at a charging port as a response to the detected decrease.

2. The charging apparatus according to claim 1, wherein the at least one charging port comprises two or more charging ports.

3. The charging apparatus according to claim 2, wherein the circuitry is configured to provide to each charging port an equal charging power.

4. The charging apparatus according to claim 2, wherein the charging apparatus is configured to detect a priority configuration, and to limit the electric power in one charging port according to the priority configuration.

5. The charging apparatus according to claim 4, wherein the priority configuration is configured to prioritize a first connected battery.

6. The charging apparatus according to claim 4, wherein the priority configuration is configured to prioritize a battery having a priority indication.

7. A mining machine charging arrangement comprising:
an electrical substation located in a mine, wherein the electrical substation is connected to a distribution network line;
a feeding line in a mine tunnel, wherein the feeding line is connected to the electrical substation; and
a charging apparatus according to claim 1, wherein the charging apparatus is connected to the feeding line.

8. A method for charging a battery in a mine comprising:
initiating a charging session;
monitoring an incoming voltage at a charging arrangement;
detecting a decrease in the monitored incoming voltage; and
limiting a charging power of the charging session.

9. The method according to claim 8, further comprising starting at least one additional charging session.

10. The method according to claim 9, further comprising limiting charging power in each of the charging sessions equally.

11. The method according to claim 9, further comprising:
detecting priority configuration; and
limiting the charging power according to the priority configuration.

12. The method according to claim 11, further comprising prioritizing the first started charging session.

13. The method according to claim 11, further comprising prioritizing the charging session comprising a priority indication.

14. A computer program comprising instructions, which when executed by a computing device, cause the computing device to carry out the method according claim 8.
